(19) United States
(12) Patent Application Publication
(10) Pub. No.: US 2013/0013581 A1
(43) Pub. Date: Jan. 10, 2013

(54) SYSTEMS AND METHODS FOR ONLINE CONTENT SEARCHING

(75) Inventors: Michael C. Pousti, San Diego, CA (US); Andrew Ballester, San Diego, CA (US)

(73) Assignee: SMS.ac, Inc., San Diego, CA (US)

(21) Appl. No.: 13/617,832

(22) Filed: Sep. 14, 2012

Related U.S. Application Data
(63) Continuation of application No. 12/119,314, filed on May 12, 2008, now abandoned.
Application No. 12/119,314 is a continuation-in-part of application No. 11/516,921, filed on Sep. 6, 2006, now Pat. No. 7,826,829.
(60) Provisional application No. 60/917,564, filed on May 11, 2007.

(51) Int. Cl. G06F 17/30

(52) U.S. Cl. 707/706; 707/E17.108

(57) ABSTRACT

A search engine that can be configured to combine information related to a web page (channel) or content file view and/or “click throughs” with revenue information in order to determine relevance of the various matched content listed in the search results, is disclosed. By combining revenue information with page view/click through information, potentially more relevant results can be presented to the user for viewing.

### RELATED APPLICATIONS INFORMATION

This application claims the benefit under 35 U.S.C. §120 to U.S. patent application Ser. No. 12/119,314 filed May 12, 2009, entitled “Systems and Methods for Online Content Searching,” which in turn claims the benefit under 35 U.S.C. §119(e) of U.S. Provisional Application Ser. No. 60/917,564 filed May 11, 2007, entitled “Systems and Methods for Online Content Searching.” U.S. patent application Ser. No. 12/119,314 also claims the benefit as a Continuation-In-Part under 35 U.S.C. §120 to U.S. patent application Ser. No. 11/516,921, filed Sep. 6, 2006, entitled “Automated Billing and Distribution Platform for Application Providers.”

U.S. patent application Ser. No. 12/119,314 is also related to commonly-owned U.S. patent application Ser. No. 11/446,973, filed Jun. 6, 2006, entitled “Billing Systems and Methods for Micro-Transactions.” The entireties of the disclosures of the above-identified applications are incorporated herein by reference as though set forth in full.

### BACKGROUND INFORMATION

1. Field

The embodiments described herein relate to Internet searching, and more particularly to providing highly relevant search results for Internet searches.

2. Background

Internet search engines are well known and often used tools for finding information related to an unlimited number of topics online. As is well understood, a typical Internet search involves accessing a search engine web page or search tool bar, e.g., included or installed in conventional browser window, and entering a search term. When the user hits enter or search, the search engine scans the Internet, or more specifically the World Wide Web (WWW) to find pages or links that appear relevant based on the search term(s) entered. A list is then displayed in the users browser, ideally with the more relevant pages or links listed first. The search engine produces the list by scanning a multitude of web pages trying to find relevant content or information. For example, a search engine will scan the content, titles, descriptions, meta data, etc., for a variety of pages on the WWW looking for relevant words or information.

What is not so well known, or understood is how the search engine determines the degree of relevance. This is a very important, if not the most important feature of a search engine. If the list produced by the search engine does not appear to contain relevant pages or information, then the user will likely stop using that search engine. Thus, the algorithm implemented by the search engine for producing highly relevant results will determine the success of the search engine.

More and more companies are trying to monetize the Internet or WWW by offering products or service through their websites. Often, the success of such companies hinges on how often their website shows up in the search results produced by various search engines, especially when the user is actually looking for the type of service or product being offered through the website. Accordingly, these companies also have an interest in how the search results are prioritized. These interests often coincide to some degree. For example, if a user is looking for products or services related to a certain topic, they would likely want their search to produce links to websites that offer such products and services. Moreover, the user would likely want the list to be prioritized with the most popular websites at the top.

Conventional search engines attempt to prioritize the most relevant pages or links using a variety of algorithms. For example, such search engines may look at how often a page was viewed and/or a link was activated. Such link activations are also known as “click throughs,” as in the number of times a link was clicked on. Thus, some conventional search algorithms use page views and click throughs to determine relevance; however, this does not always produce the best results.

### SUMMARY

A search engine can be configured to combine information related to web page or content file view and/or click throughs with revenue information in order to determine relevance and generate a list of search results. By combining revenue information with page view/click through information, potentially more relevant results can be obtained.

In one aspect, the revenue information can be normalized for the number of click throughs. In other words, the search results can be prioritized based on how often a web site (channel) or content file is able to monetize a click through.

In another aspect, for web sites or content files that have no click throughs but are generating revenue, then the search results can be prioritized based on the amount of revenue over a certain time period, such as a previous number of days or weeks.

In still another aspect, for websites or content files that have click throughs but no revenue, then the search results can be prioritized based on the number of click throughs over a certain time period, such as a prior number of days or weeks.

In still another aspect, for websites and content files that have no revenue and no click throughs, then the search results can be prioritized based on the number of page views over a certain time period, such as a prior number of days or weeks.

In still another embodiment, some combination of the above prioritization methods can be used in order to sort all search results for presentation to the user.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a block diagram that illustrates an exemplary computer system that can be configured to implement the systems and methods described herein;

FIG. 2 is a block diagram that illustrated a computer-based mobile community in accordance with one embodiment;

FIG. 3 is a block diagram that illustrates a more detailed view of the high-level system view of FIG. 2;

FIG. 4 is a flowchart illustrating an example method for distributing software via the mobile community architecture of FIG. 2;

FIGS. 5-8 are screenshots illustrating example windows that software developers may be presented to assist in registering a new pod with the mobile community architecture of FIG. 2;

FIG. 9 is a diagram illustrating an example pod that can be developed and registered using the process depicted in screenshots 5-8;

FIG. 10 is a diagram illustrating an example user profile page that can include pods, such as the pod of FIG. 9, and can be hosted by the mobile community architecture of FIG. 2;

FIG. 11 is a flowchart illustrating an example method for a user to add a pod to their profile page;

FIGS. 12 and 13 are flowcharts illustrating the operation of a pod and its associated pod application within the mobile community of FIG. 2;

FIG. 14 is a block diagram of a global mobile platform that can be included in the computer-based global mobile community of FIG. 3;

FIG. 15 is a diagram illustrating how content search engine operates in conjunction with the other elements of the mobile community platform to provide search engine functionality to mobile community members, in accordance with one embodiment;

FIG. 16 is an example process for searching a mobile community platform for content and prioritizing the content search results based on one or more content metrics, in accordance with one embodiment;

FIG. 17 is an example of a standalone content search results page generated by the content search engine, in accordance with one embodiment; and

FIG. 18 is a logic flow diagram that illustrates the operation of the content search algorithm to enable a mobile community platform user to search the community platform for relevant content, in accordance with one embodiment.

### DETAILED DESCRIPTION

A mobile community platform (or network community platform) is described below on which a search engine configured in accordance with the systems and methods described herein can be implemented. It will be understood, however, that the mobile community platform described below is by way of example and that the search techniques described herein can be implemented on a variety of platforms. As such, the embodiments described below should not be viewed as limiting the systems and methods described herein to a particular platform or architecture.

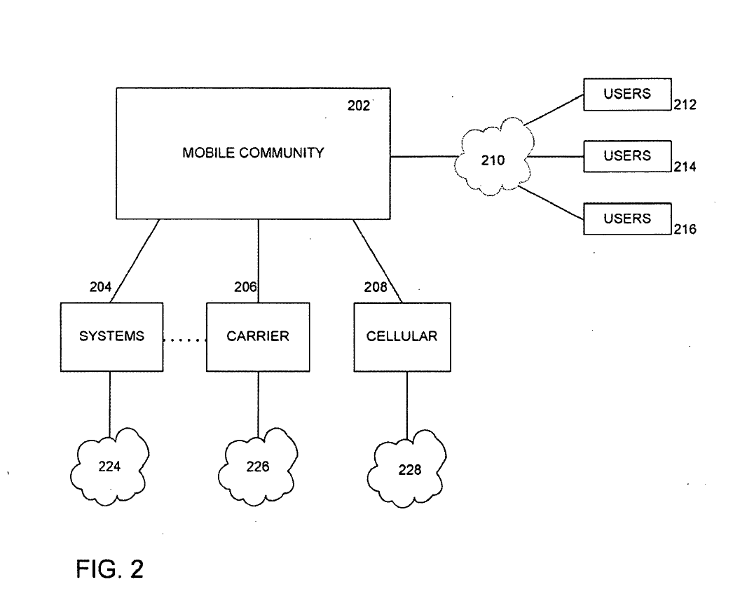

FIG. 2 depicts a block diagram of a computer-based mobile community 202. Users 212, 214, 216 can connect to the mobile community 202 via a network or similar communications channel 210. Via the connection, a user (e.g., 212) may create a profile page or “home page” that they can personalize. This profile page can include various files and content that the user wants to share with other members of the mobile community 202.

The profile page may include a hierarchy of pages or collection of web pages that are hosted on the Internet, some of which are for public view and some of which have restrictions on viewing. For example, the mobile community 202 can be logically organized into neighborhoods such as “friends”, “family”, “workplace”, “dog owners”, etc. Users 212, 214, 216 can belong to these different neighborhoods and share different pages with the members of the different neighborhoods.

Additionally, this mobile community 202 can connect with various cellular carrier systems 204, 206, 208, each of which has an associated community of mobile phone subscribers, 224, 226 and 228. Users 212, 214, 216 of the mobile community 202 are also subscribers of various cellular carriers. In this way, users 212, 214, 216 of the mobile community 202 not only have access through the computer-based platform 202 to other users' profile pages, they also have easy access to subscribers of the various cellular carrier systems 204, 206, 208.

A benefit of the architecture depicted in FIG. 2, is that the mobile community platform 202 has already contracted for services with the cellular carrier systems 204, 206, 208. As is known in the art, the cellular carrier systems 204, 206, 208 provide messaging and premium message functionality. Such messages are sent via the cellular carrier's infrastructure to mobile subscribers and, internal to the cellular carrier's infrastructure, generates a billing event according to a particular tariff rate. In practice, when the mobile community 202 sends a message via a cellular carrier system (e.g., 204), it is billing the recipient of the message using the existing billing system of that cellular carrier. The billing event is often a micro-transaction. Thus, a user (e.g., 212) of the mobile community may conduct transactions with a vendor within the mobile community 202 and be billed for those transactions via their cellular service account. The vendor in the transaction need only communicate with the mobile community 202 regarding the transaction and does not require any affiliation or agreement with any cellular carrier.

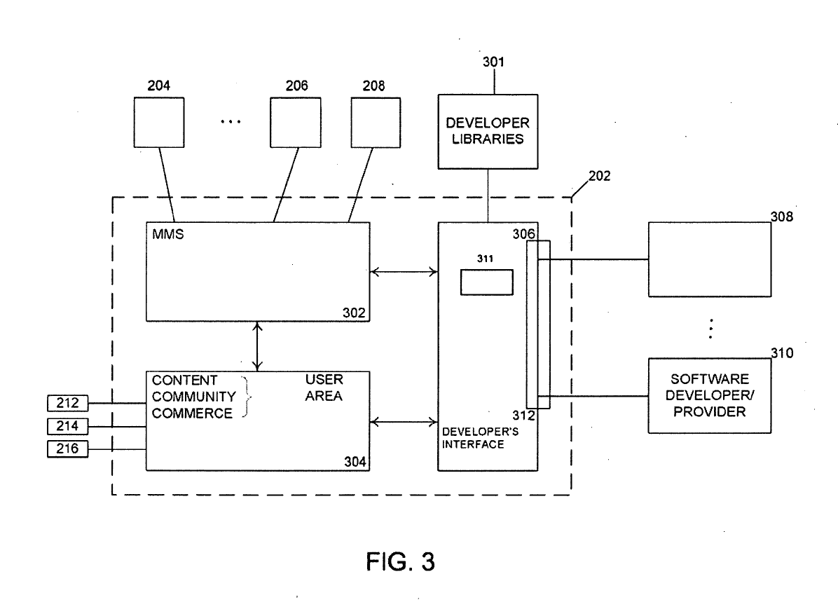

FIG. 3 depicts a more detailed view of the high-level system view of FIG. 2. In particular, the system of FIG. 3 can be used to conduct micro-transaction in which a cellular carrier's billing system is used by the mobile community 202 platform to automatically bill the user for each micro-transactions with a vendor/retailer, without the need for a negotiation or contract between the vendor and the cellular carrier. One example of this feature is that of software content distribution where software developers can offer software products to the users of the mobile community 202, while taking advantage of the billing arrangements already in place between the mobile community 202 and the cellular carriers 204, 206, 208. Of course, a software application may provide any other type of content or service to users of mobile community 202.

Some of the sub-components of the mobile community 202 are a global mobile platform 306, the user area 304 where the content, community and commerce functions are handled for the users, and a multimedia messaging system 302. The details of these different sub-components are more fully explained throughout the remainder of this detailed description.

As noted earlier, users 212, 214, 216 can visit the user area 304 to participate in an on-line community that includes various content and commerce opportunities. This is typically accomplished via a user's web browser that may be hosted on a laptop or desktop computer, or, in the alternative, even on the user's mobile device such as a PDA or mobile phone. Thus, the user area 304 includes a web server that communicates with users 212, 214, 216 and includes a data store of user information and other content. With these resources, the mobile community 202 is able to present to a user 212 a profile page (“home page”) that reflects content and information associated with, and desired by, that particular user. This content and information is not maintained on the local computer being used by the user 212 but, rather, is maintained and managed by the computer systems within the user area 304.

Although not explicitly depicted in FIG. 3, one of ordinary skill will recognize that there are numerous functionally equivalent techniques to create, manage, store and serve user information, user profiles, user content, software tools and other resources within the user area 304. Included in these techniques are methods to ensure security, data integrity, data availability and quality of service metrics.

The multimedia messaging system 302 includes applications for connecting with and communicating with the multiple different cellular carriers 204, 206, 208 that have been partnered with the platform of mobile community 202. The MMS 302 is configured to generate message requests in the appropriate format for each of the cellular carriers 204, 206, 208 including tariff information that determines the amount for which the recipient of the message will be charged. Upon receipt of the message request, the cellular carriers 204, 206, 208 will use the information in the request to generate an appropriate message to the intended recipient/subscriber of the cellular carrier and then bill the recipient/subscriber's cellular service account for the specified amount.

The MMS 302 communicates with the user area 304, such that users of the mobile community 202 can advantageously use the connectivity of the MMS 302 with the carriers in order to send messages to subscribers of any of the cellular carriers 204, 206, 208. The messages may be SMS messages, MMS messages, or other message formats that are subsequently developed. Some of these messages may have zero tariff and, therefore do not generate a bill (other than the underlying charges implemented by the cellular carrier) and others may have non-zero tariffs resulting in a billing event for the recipient.

The global mobile platform 306 provides a link between software developers/providers 308, 310 and the mobile community 202. In particular, using an interface 312 (described in more detail herein), a software provider 308, 310 may offer services and products to users 212, 214, 216. Advantageously for the software provider 308, 310, the global mobile platform 306 also provides automatic and instant connectivity to the MMS 302 and the cellular carriers 204, 206, 208. Accordingly, the software provider 308, 310 can interact with all users of the mobile community 202 whereby billable transactions with users 212, 214, 216 are automatically billed via the billing systems of the cellular carriers 204, 206, 208. Furthermore, and importantly, this capability is available to the software provider 308, 310 without requiring the software provider 308, 310 to negotiate or contract with any cellular carrier for billing arrangements, or to worry about how to communicate with a cellular carrier's systems and resources. The software provider seamlessly takes advantage of the unified set of connectivity and billing arrangements that exist between the mobile community 202 and the cellular carriers 204, 206, 208. Thus, in addition to the contractual arrangements and affiliations the mobile community 202 has in place with different carriers 204, 206, 208, the underlying technical and communications infrastructure is also in place to communicate with and interoperate with each of the different carriers 204, 206, 208. As a result, vendors and other members of the mobile community may interface with and operate with any of a variety of different carriers without difficulty.

While some software applications that are available to users 212, 214, 216 may be hosted in the user area 304, the global mobile platform 306, or elsewhere in the community 202, it is often the case that the software developer/provider 308, 310 will host their own software application at their own remote location. Accordingly, in the description that follows, even if remotely-hosted software is being discussed in a specific example, one of ordinary skill will readily appreciate that software application being hosted differently is also expressly contemplated.

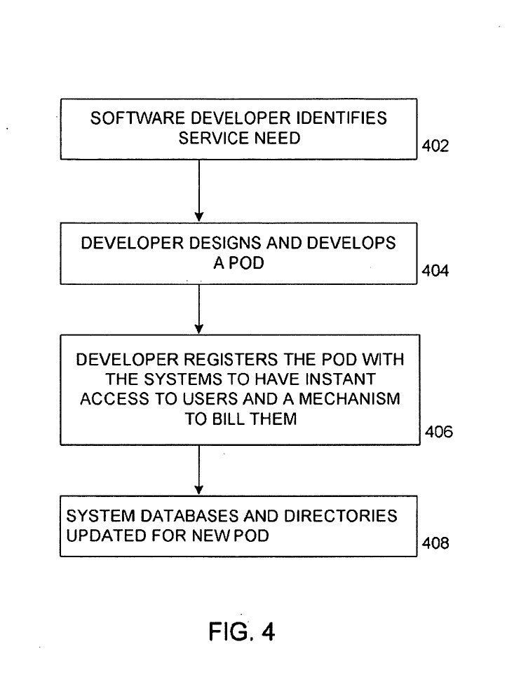

FIG. 4 depicts a flowchart of an exemplary method for distributing software via the mobile community architecture of FIG. 2. In a first step 402, a software developer identifies a marketplace need that is not being fulfilled. In other words, the software developers believes that there is a service or product that they can provide that will be profitable. The variety of different types of services, content and products that can be offered to users via a software application is limited only by the imagination of the different software developers.

The term “pod service” or “pod application” is used in the following description as a label for software applications offered through the mobile community 202. This label is used merely for convenience and is not intend to limit or restrict the types, variety and capabilities of potential software applications in any way. As used herein, the term “pod” refers both to the underlying information related to the pod application and to the graphical rendering of the pod application on a user's profile page within the mobile community 202.

Once the marketplace is identified, the developer commences development of their software application in step 404. The underlying application logic is up to the developer and can utilize any of the widely known programming environments and techniques available to one of ordinary skill in this area. However, the software application will be offered within the mobile community 202 along with a variety of other software applications. Accordingly, standardizing the look and feel of the application and information about the application will aid the users 212, 214, 216 and make their community experience more enjoyable.

Once a pod application has been developed (and most likely tested and verified) by a developer, the developer registers, in step 406, the pod application with the global mobile platform. Registering the pod application, which is described in more detail later with reference to a number of screenshots, allows the software developer to inform the global mobile platform 306 that a new pod application is available for the access by mobile community 202.

Once a pod application is registered, the global mobile platform 306 updates, in step 408, system databases and directories for the new pod application and its associated information. In the above description of FIG. 4, it is evident that the pod developer communicates with the mobile community 202 for a number of different reasons. One of ordinary skill will recognize that these various communications between the pod developer and the mobile community can occur via any of a variety of functionally equivalent means. For example, both wired and wireless communication methods for these communications are explicitly contemplated within the scope of the present invention.

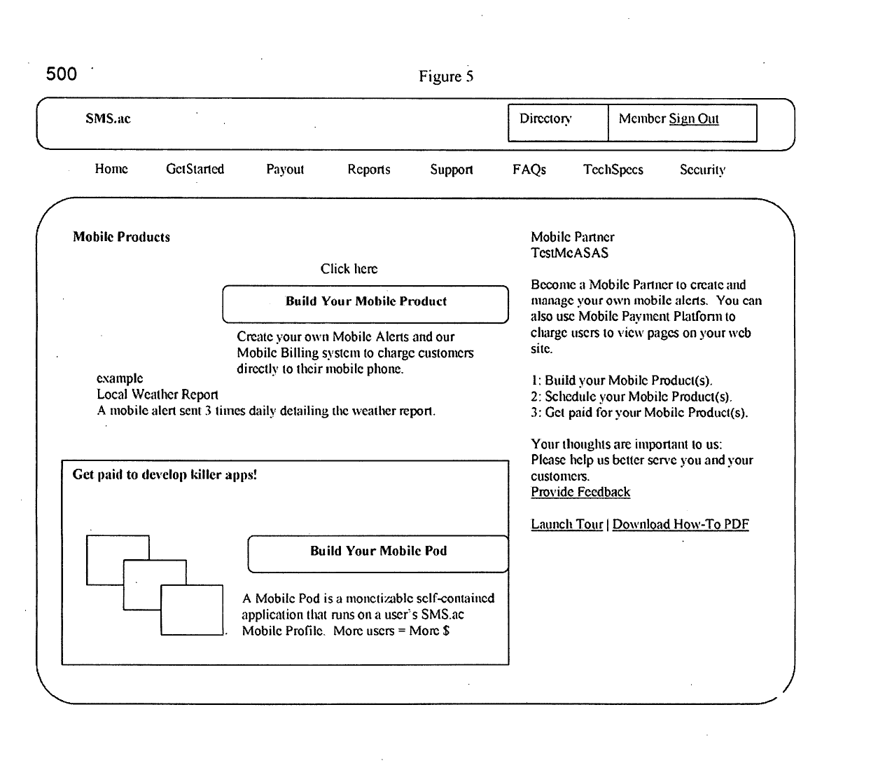

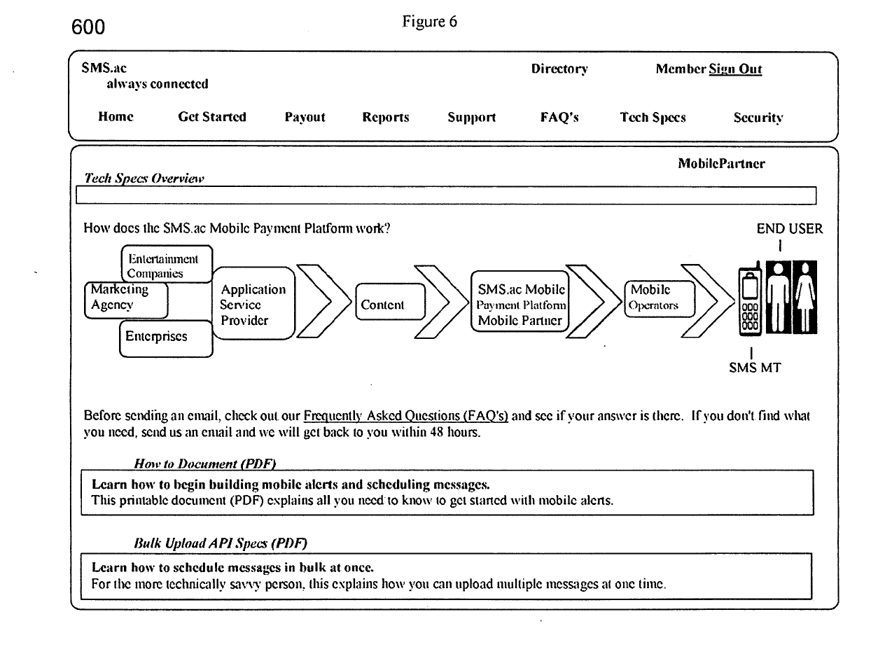

FIG. 5 is a screenshot of an exemplary window that software developers may be presented to assist in registering a new pod. From this screen, the software developer can navigate to a screen that provides more technical information such as the one shown in FIG. 6. This screen illustrates to the developer how the pod application takes advantage of the existing mobile payment platform when used by an end user.

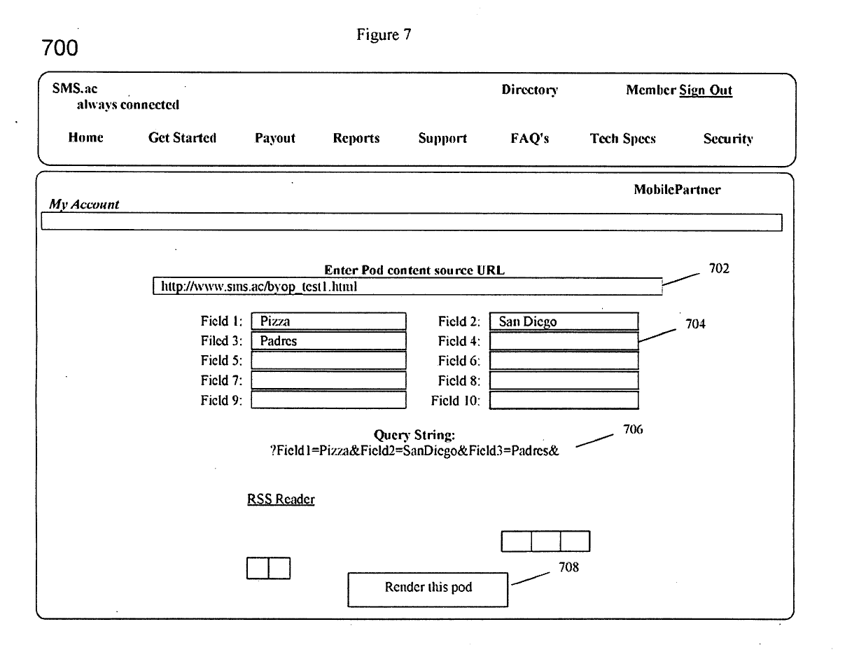

FIG. 7 is a screenshot of an exemplary pod registration screen. Because the pod application is most likely hosted remotely, an input window 702 allows the pod developer to provide the URL of where the pod application is located. When a user ultimately uses the pod within the community 202, this URL is the location from where the content for the pod application is retrieved. For example, if the pod application was developed to display pictures for a dating service, this URL would point to code that when executed could detect user input events and result in the display of appropriate images.

The pod developer can utilize the field input boxes 704 to specify different fields that can capture input when a user first accesses a pod. For example, if a pod application is developed to provide stock quotes, then these fields could be defined to accept stock symbols. When the user views the pod within their profile page, these fields can be filled in with appropriate stock symbols, for example. When the user then selects a “submit” button, this information is sent to the pod application which returns the appropriate information.

As is well known to HTML and HTTP developers, based on the information that is filled in the field windows 704, a particular query string will be appended to a request received from a user's form submission. To aid a developer in registering a pod, this query string is automatically generated and displayed for the pod developer in region 706 of the exemplary screen. To give the pod developer a quick view of how the pod will be rendered, a button 708 is provided to illustrate the pod. With this information, the developer may choose to revise their design.

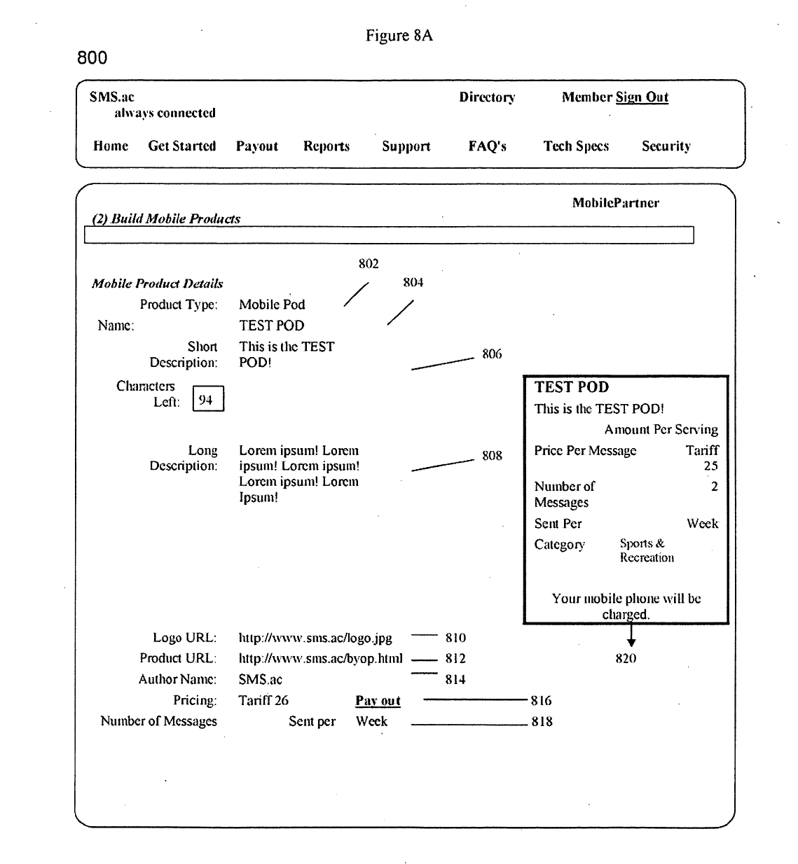

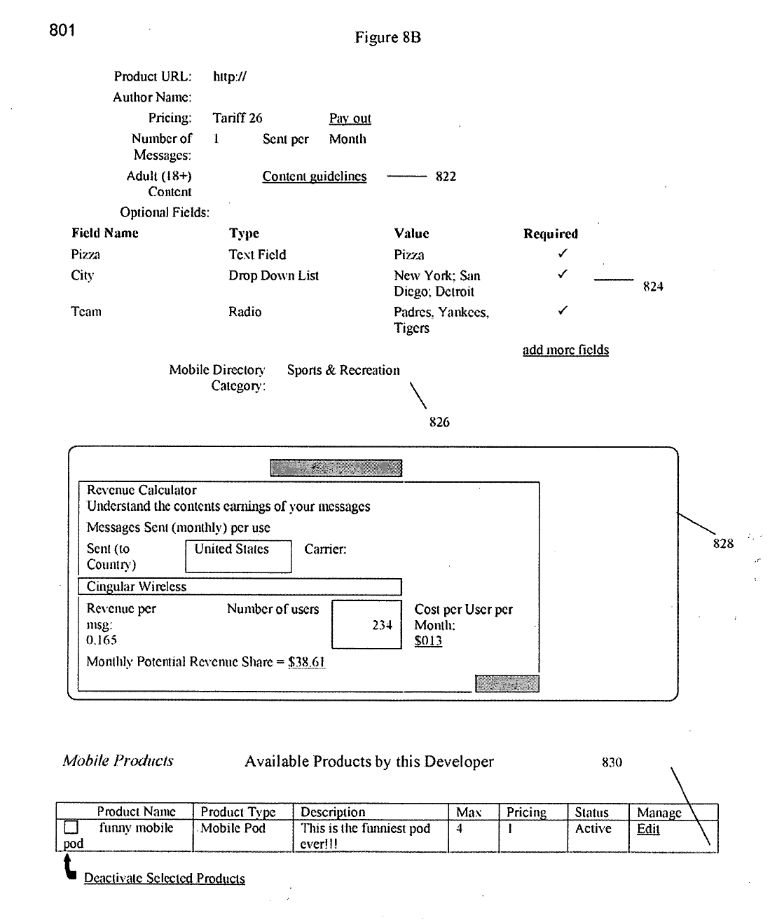

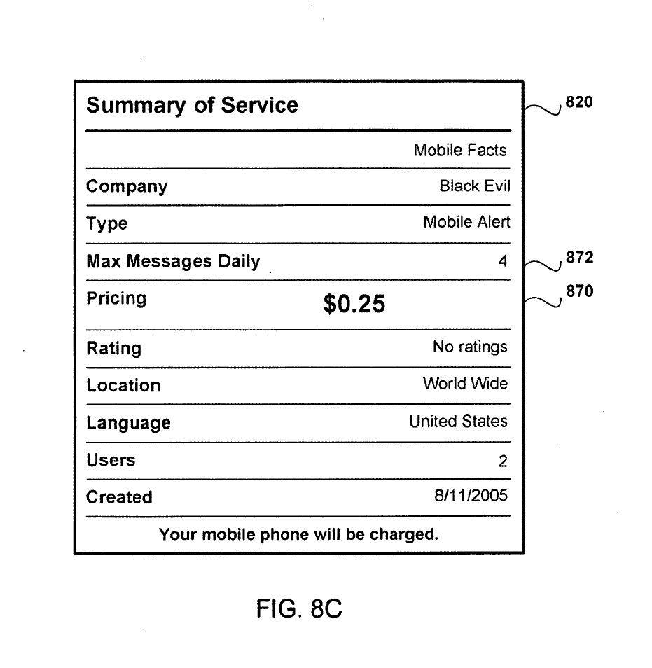

Once this initial information is collected, the global mobile platform 306 collects additional information that is associated with the pod. In FIGS. 8A and 8B, a number of input fields 802-830 are provided for the pod developer to fill in while registering their pod application. Many of these fields are self-explanatory; however, some warrant a more detailed discussion. In particular, a pricing window 816 is available for the developer to select an appropriate pricing scheme, according to a standardized pricing structure. According to one embodiment of the present invention, pricing occurs in fixed tariff bands. For example, one band would be a $0.25 band and would be used for products or services that the developer thinks users would purchase for around $0.25. Another band may be $1.00 and would be for higher priced items and still other bands can be used as well. According to this arrangement, not all prices are available to the developer; instead, the developer picks the closest band to use (e.g., the $1.00 band is selected even if market research shows users would actually pay $1.03 for the service).

Additionally, the pod application will likely be used by people in different countries. Because of the vagaries of global economics, $0.25 may be too high of a price-point in many countries. Thus, it is more appropriate to set a price-point for each separate country from which the pod application may be used. While it is possible for the global mobile platform 306 to permit the pod developer to set such a vast number of price-points, most developers will not have the knowledge or the patience to perform such a task. Accordingly, the global mobile platform 306, automatically provides a price band selection for each country based on their respective costs of living. In other words, a developer can select a price band in the currency that he is comfortable with and let the global mobile platform 306 translate that to an equivalent price band in each country.

Via the input field 818, the developer also specifies the number of messages and frequency that their pod application will send to each user. Based on their knowledge of having developed the pod application to perform a particular service, the pod developer may, for example, know that no more than 4 messages per day (per user) will be sent from their pod application. This information sets the terms and conditions for billing the user. Thus, they would fill in this field 818 accordingly. As explained later, the global mobile platform 306 can use this information to control message traffic within the community 202.

The benefit of specifying the pricing information and number of message information is that the terms and conditions of the pod application can be provided to a user in a uniform manner. Window 820 displays, for the pod developer, how the pod application information, including pricing, terms and conditions, will be shown to a user. FIG. 8C depicts a more detailed view of this uniform pricing display. Much, like nutritional labels on food products provide a uniform format for presenting the nutritional information, the format depicted in window 820 can be used to uniformly present information about pod applications. Thus, a user of the community does not have to learn and interpret different pricing information for each different pod developer. Instead, the uniform format 820 simplifies understanding this information. The exemplary format of window 820 includes a variety of information about the pod application. Of particular interest to most users is the uniform manner in which the pricing information 870 and the message information 872 is clearly presented. One of ordinary skill will appreciate that the format of window 820 is merely exemplary in nature and can vary in numerous ways without departing from the scope of the present invention. Accordingly, the exemplary format of window 820 is provided to illustrate that the global mobile platform 306 is arranged so as to provide users of the community 202 with uniformly formatted information from a variety of different pod applications so as to simplify the evaluation and comparison of different offerings. With such a uniform pricing arrangement being utilized, it becomes possible to monitor the behavior of pod developers with respect to their specified pricing structure and implement control measures such as limiting or restricting their activities within the mobile community if warranted.

Once the information of screens 8A and 8B are submitted to the global mobile platform 306, the pod application is registered with the mobile community 202. According to at least one embodiment of the present invention, the pod application is evaluated by a moderator of the mobile community 202 to ensure it is acceptable from a technical and content point of view for the community 202. In this scenario, the pod application is not registered until the evaluation is completed satisfactorily.

Information about a registered pod application is stored within the global mobile platform 306 in such a way that when a user wants to include a pod on their profile page, the pod can be rendered using the stored information and interaction between the pod and user will occur based on the stored information as well. In such a case, the data associated with the user will be updated to reflect that the user is now accessing and using the pod.

Thus, according to the previously described technique, a pod developer can automatically register a new pod application (even from a remote location) without difficulty in such a way that the pod automatically becomes available to users of the mobile community 202 at the conclusion of the registration process. Furthermore, from the pod developer's point of view, the pod application may immediately take advantage of the billing platform used by the mobile community 202 without the need to have existing contracts in place with one or more cellular carriers.

One benefit of registering pod applications in this manner is that once registered, the global mobile manager 306 can prevent the terms and condition information from being changed by the pod developer. Thus, a user's agreed upon price and operating parameters will not be modified (with or without their knowledge).

The users of the global community can locate available pod applications in a number of different ways. First, the community 202 facilitates sharing of information by people having common tastes. Accordingly, within the community users frequently visit other users profile pages looking for interesting content and information, particularly with neighborhoods to which the user belongs. During this visiting of other members' home pages, a user can discover an interesting pod and want to get it for themselves. In terms of the community, a user “owns” their own profile page and is called an “owner” when at their profile page. In contrast, when a user visits some else's profile page, they are considered a “viewer”. Within the mobile community 202, the profile pages are maintained such that the view by an owner may not always correspond to that seen by a viewer as the owner may want some information to be private and other information to be public.

In another instance, a user may know a friend or colleague would want a particular pod application; thus, the community 202 allows a user to inform another user about the existence of a new pod application. Another way in which pod applications are located is via a directory within the mobile community 202. For example, the global mobile platform 306 registers each pod application as the developers submit them; it is a simple extension to include a database update and a searchable-directory update as part of the registration process (see step 408 of FIG. 4).

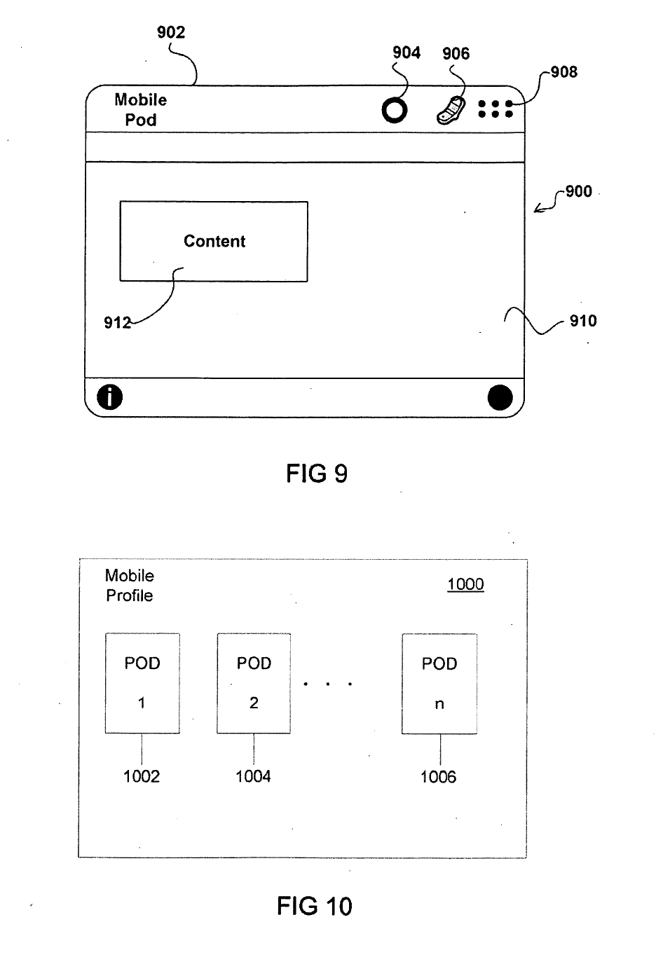

A rendering of an exemplary pod 900 is depicted in FIG. 9. The pod includes a title bar 902 with a number of icons 904-908. The main window 910 of the pod is where the content 912 is displayed. This content is based on the associated pod application and the stored system information associated with this pod. From the pod 900, a user launches an initial message to the associated pod application. In instances where the pod application provides content back to the pod 900, the window 910 is updated. By using remote scripting capability, as is known in the art, the updating of window 910 can occur without the user manually refreshing the window 910. Similar to the profile pages described earlier, the pod 900 can be designed to provide different views of content 912 to a user depending on whether the user is an “owner” or a “viewer”.

The icon 904 can be selected by a user (for example, when viewing someone else's pod) to add that pod to their own profile page. The icon 906 can be selected to inform another user about this pod and a drag icon 908 can be used to move the pod around a user interface screen. The “information” icon 914 is useful for displaying information about the pod, including the uniform pricing information described earlier.

FIG. 10 depicts a exemplary user profile page 1000 that has arranged thereon a plurality of pods 1002, 1004, 1006. In this manner, the pods available to a user can be displayed on their profile page. As noted earlier, the user can access this profile page via a number of different devices. For example, in addition to use of a traditional web browser, a portable device such as a smart phone or PDA can be used to access the profile page and pods. Such portable devices can utilize traditional WAP-based or HTML-based techniques to access the pods but they may also utilize device-based applications with proprietary protocols specifically developed to advantageously utilize the capabilities provided by pods and pod applications. Other example techniques implemented by portable devices that can be configured to access a profile page described herein include BREW, J2ME, etc.

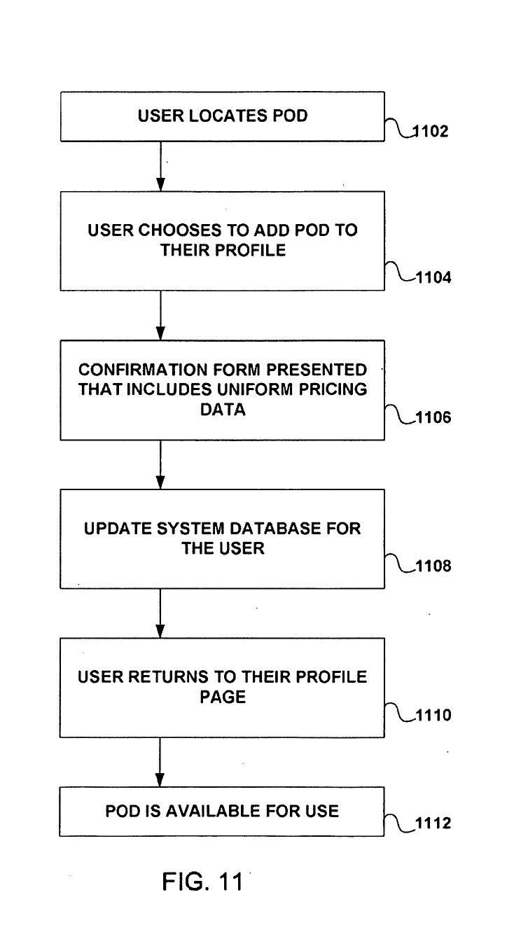

FIG. 11 illustrates a flowchart of an exemplary method for a user to add a pod to their profile page. In step 1102, the pod user locates an interesting pod via a visit to another user's profile page or through a directory search. In evaluating the pod, the user can see the terms and conditions of the pod in the uniform presentation format described earlier. Next, in step 1104, the user chooses to add the pod to their profile page; typically using a standardized feature on the pod. In step 1106, a confirmation page is sent to the user to ensure they know the pricing information about the pod and to ensure they are aware of the likelihood of their cellular service account being billed as a result of executing the pod application. Assuming the user confirms their selection, the user area 304 updates, in step 1108, its data store about this user such that the records indicate the user owns this new pod on their profile page. When the user next visits their profile page, in step 1110, and as a result of the user area 304 rendering their profile page on their browser, the new pod will be displayed. With the pod displayed within the profile page, it is now available for use by the user, in step 1112.

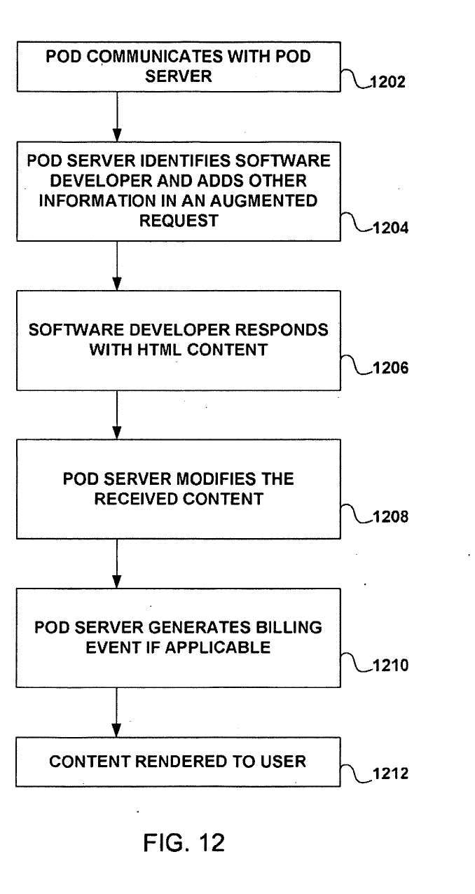

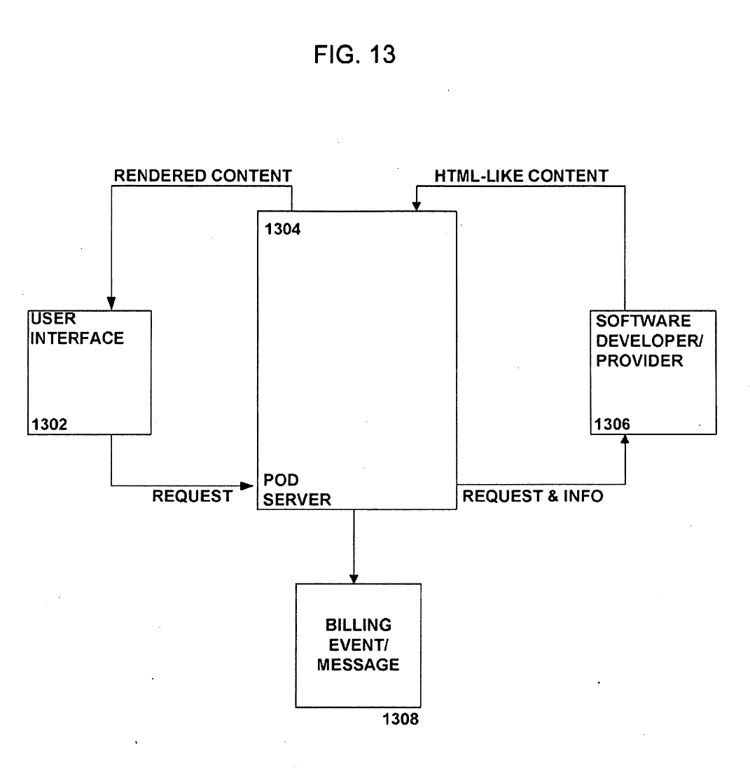

FIGS. 12 and 13 illustrate the operation of a pod and its associated pod application within the mobile community 202. As known to one of ordinary skill, the pod server 1304 may be a process executing on a separate, dedicated processor or may be included as part of the user area 304 or the global mobile platform 306. In step 1202, a user interacts with some feature on the pod user interface 1302 to generate a request. This request, includes the URL associated with the content of the pod and a query string (if any) based on the fields of the pod, and information input by the user. The query string is sometimes referred to as transient parameters.

In response to the request from the pod user interface, 1302, the pod server 1304 identifies the pod developer and the URL of the content and adds some additional information, in step 1204. The augmented request is sent to the software provider's application 1306 which responds, in step 1204, to the augmented request.

The information added to the augmented can request include demographic information about the owner and viewer of the pod. In this way, the software application 1306 can respond with a first type of content if the owner and viewer are the same or respond with different content if the owner and viewer are different. One way to accomplish this distinction is for the user area 304 to refer to users by a unique user ID number. Thus, users can be distinguished without revealing sensitive information to a software developer such as the mobile telephone number of a user. Also, the software application 1306 can use this demographic information to collect statistics about its users.

Other additional information that might be added would include details about the type of user interface the user has available. Because users may be using their mobile device, their display may not be as robust as a desktop interface. Thus, a software application 1306 can control content based on the current graphical and bandwidth capabilities of the user. For example, the additional information can indicate whether the user is operating in a web-based or mobile-based environment, e.g., a WAP, BREW, J2ME, etc., based environment.

In response to the augmented request, the software application 1306 responds with code, in step 1206, that is substantially HTML data. This code is generated according to the application logic of the pod application 1306. In other words, it is the content that is returned to the user who is viewing the pod. In certain embodiments of the present invention, the code of the response varies from conventional HTML in certain ways. For example, because this is a managed communication system, non-standard HTML tags can be used and supported. Thus, non-standard tags can be used that are specific to the pod environment that are not applicable to generic HTML pages. For example, a pod has a title area and a message area. Tags specifically for controlling these areas may be used to add functionality to the pod environment described herein. One of ordinary skill will recognize that a number of different specialized tags and capabilities can be offered without departing from the scope of the present invention.

An additional variation from HTML is that of using templates where information can be provided by the pod server 1304. For example, for privacy concerns, little identifying information is sent to the software application 1306. However, the pod server 1304 has access to this information because it communicates with the user information stored in the user area 304. Thus, the use of templates will allow software applications 1306 to take advantage of this information to personalize the pod experience. For example, the template may include a tag <! FirstName !>. When the pod server 1304 encounters this tag in the template, it knows that the software application 1306 intends for the pod server to insert the first name of the user. A more detailed list of exemplary template tags is provided in the previously mentioned incorporated document.

When the pod server 1304 receives the HTML-like reply from the software application 1306, the pod server manipulates the reply into a format useful for the pod environment. For example, certain HTML features such as, for example, javascript, iframe, frame, and script features, are removed from the reply in order to improve the security of the content. Secondly, the pod server 1304 can replace the personalizable parameters in the templates with the actual user information. And thirdly, the pod server 1304 can translate the content into other display formats, depending on the operating environment of the user (mobile or computer).

For example, if a software provider is well-skilled in providing WAP code as opposed to conventional HTML code, then that provider can control which code, or content, is generated based on the information it knows about the user's interface. However, if a software provider is not skilled with, or does not support, generating content in different formats, then the software application can request (as part of the code it sends back to the pod server 1304) that the pod server 1304 translate the code into a more appropriate format.

Another modification the pod server 1304 can make is that of manipulating the hyperlinks within the code sent by the software provider. Under normal behavior, such a hyperlink would result in opening another browser window and following the link. As is known to one skilled in this area, the original hyperlinks are adjusted by the pod server 1304 so that following of the links remains under the control of the pod server 1304 and the user interface remains within the focus of the pod instead of some other browser window.

Once the pod server 1304 completes its changes to the original code in step 1208, the server 1304 renders the code and content to the user's pod 1302, in step 1212.

In addition to the code that is received from the software application 1306, the pod server 1304 can also receive information from the software application 1306 about a billing event that should be triggered for the particular content that the user requested. For example, the user may have requested a stock quote that will cost $1.00. When the application 1306 generates the content of the reply, it also generates a message that the pod user should be charged $1.00 for this transaction. One of ordinary skill will appreciate that there is wide variety of protocols for the pod server 1304 and the software application 1306 to exchange information related to a billable transaction. During operation, therefore, the software developer's application 1306 merely adheres to the agreed upon protocols to inform the pod server 1304 that a billable transaction has occurred.

When the pod server 1304 determines that the code from the application 1306 includes an indication that billing should occur, the pod server 1304 generates a billing event 1308, in step 1210. This billing event 1308 is forwarded to the global mobile platform 306 so that billing may occur by using the cellular carrier's underlying billing systems. The pod server 1304 has access to the recipient information (i.e., the pod user) and the billing rate of the pod application 1306. Therefore, an appropriately formatted billing message is easily generated.

The global mobile platform 306 includes a message interface 1402 to handle billing events from a variety of sources. Although a different interface could be designed for each different source of billing events, it is more efficient to use a single Application Programming Interface (API).

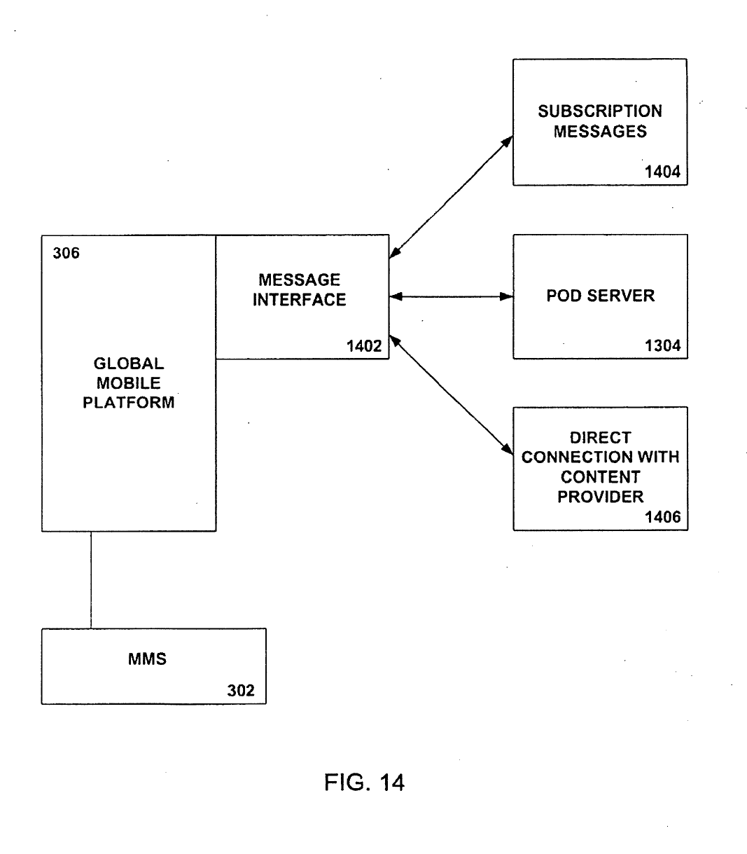

One type of billing message originates from subscription-based services. Under these circumstances, a database or other storage system maintains a record of when to send a message to a user on a predetermined periodic basis (e.g., daily, monthly, weekly, etc.). When the management system for these subscription services indicate that a message is to be sent, then this message is forwarded to the interface 1402 (FIG. 14) of the global mobile platform 306 with the appropriate tariff information included.

As discussed earlier, the pod server 1304 can also generate a message based on a discrete billable event occurring due to the user's operation of a pod application. In this instance the billing message 1308 is forwarded to the interface 1402.

In another circumstance, the pod application may operate so as to avoid sending content back through the pod server 1304 but still be designed to perform a billable event. For example, the pod application may be a virtual greeting card application that sends text messages to people based on whether it is their birthday, anniversary, etc. and charges the pod user $0.25 for each card. Thus, the pod application 1306 performs billable activities but not via the content it sends back through the pod server 1304. Under these event-based circumstances, the software provider can establish a direct connection with the interface 1402 and send a billable message via the established API.

Regardless of how the billable event arrives at the interface 1402, the global mobile platform 306 processes it such that a message is sent via the MMS 302 through the cellular carriers to the user of the pod. This message, the content of which may say, for example, “Thank you for being a valued customer of xxx” will have associated with it a tariff code that results in the user being billed via their cellular service account.

Thus, a business model is established where the cellular carrier bills a user for various events and shares an agreed-upon portion of that billing with the mobile community platform who, in turn, shares an agreed-upon portion of that billing with the software provider. The carrier benefits from additional billable data traffic and the software provider benefits by obtaining instant access to all the users of the mobile community as well as instant access to the cellular carriers' billing systems in a seamless and unified fashion through the platform.

The presence of the global mobile platform 306 between the software provider's application 1306 and the MMS 302 provides the benefit that the messaging of different users of the mobile community 202 can be controlled to ensure the mobile community 202 is more enjoyable.

Within the mobile community, the various computer-based components discussed thus far have a vast amount of information stored and readily accessible. For example some of the information includes: identifying information about each pod application, identifying information about each user, identifying information about which pods are associated with each user, information about the terms and conditions regulating the operations of a pod application, and information about messages being sent via the mobile community (i.e., network community platform. With this information available, one of ordinary skill will recognize that a number of operating parameters of the mobile community can be monitored and controlled.

In certain embodiments, mobile platform can be configured to provide search engine functionality to users and mobile users. Thus, when a user accesses their profile page they can also have access to the search engine functionality. This functionality can be included as a separate search page or as a window or search bar in the user's profile page. When a user initiates a search, the search engine can scan the content pages within mobile platform (i.e., network community platform), as well as content pages outside of platform, and produce a list of prioritized search results. Additionally, as discussed below, the search engine can be configured to search various content channels for specific content and return a prioritized list of channels. Unlike conventional search engines, however, the search results can be prioritized based on revenue information associated with the pages returned by the search.

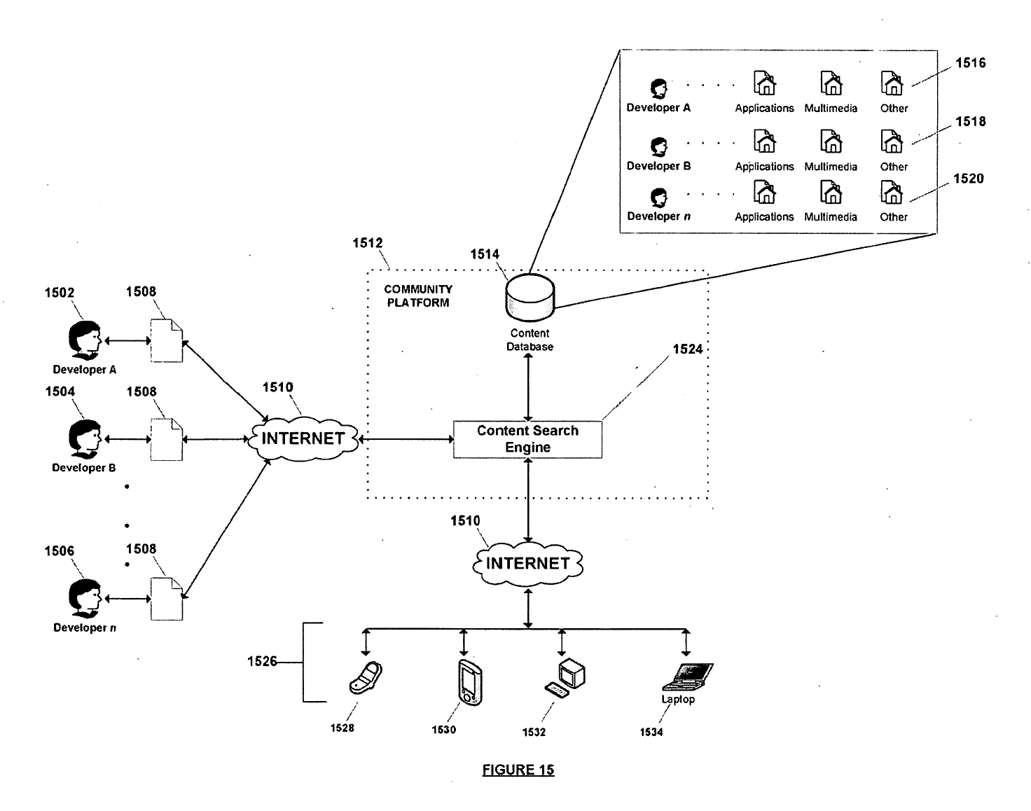

FIG. 15 is a diagram illustrating how content search engine operates in conjunction with the other elements of the mobile community platform to provide search engine functionality to mobile community members, in accordance with one embodiment. As depicted, herein, the mobile community platform 1512 can include a content search engine 1524 and a content database 1514. In one embodiment, the content search engine 1524 and the content database 1514 all reside on separate servers/computing devices that are communicatively connected to each other by way of “hardwire” or “wireless” connections. For example, the content search engine 1524 can reside on an application server that can be communicatively connected via “hardwire” connection (Category 5 (CATS), fiber optic or equivalent cabling) and/or “wireless” connection (e.g., Wi-Fi, Bluetooth, etc.) to the data server(s) that host the content database 1514. In another embodiment, the content search engine 1524 and the content database 1514 all reside on the same server/computing device. For example, a network mainframe/server, a desktop personal computer or a mobile computing device (e.g., wireless PDA, cell phone, tablet PC, etc.). In still another embodiment, the data stored into the content database 1514 can be distributed out amongst one or more different database types (e.g., content metrics database, mobile community user database, etc.).

As used herein, a third-party content developer is any individual or group of individuals (public or private) that is registered as a content 1508 provider with the mobile community 1512. As shown in the diagram, third-party content developers (Developer A 1502, Developer B 1504, Developer n 1506) can create various types of content 1508 (e.g., pod applications, multimedia files, podcasts, etc.) for upload to the mobile community platform 1512. Examples of third-party developer content 1508 include, but are not limited to: software applications (pod applications), music file (multimedia files), video files (multimedia files), short stories, podcasts, blogs, etc. It should be understood, that the content 1508 upload can entail an upload of the actual content 1508 file itself or just a Universal Resource Locator (URL) link to the server or computing device where the content 1508 file is stored.

Once uploaded, the third-party developer content 1508 can be stored in a content database 1514 that can be configured to allow the content 1508 to be accessed by the third-party developer, mobile community members 1526, and/or the content search engine 1524. Moreover, the content 1508 stored in the content database 1514 can be arranged such that each content 1508 file can be associated with the third-party developer who created and/or uploaded it to the database 1514 and to allow for tracking of content metrics (e.g., content revenue, content views, content downloads, etc.) that convey information regarding how mobile community members/users 1526 interact with the content 1508. For example, as depicted in FIG. 15, the content database 1514 can track the applications, multimedia and other files that are uploaded by Developer A (1516), Developer B (1518), and Developer n (1520).

Mobile community platform members or new users 1526 can utilize a variety of different types of devices to interface with the mobile community 1512 via an Internet connection 1510. Examples of the types of devices that can be used include, but not limited to, laptop PCs 1534, desktop PCs 1532, mobile phones 1528, PDAs 1530, etc. In one embodiment, when a member/user 1526 arrives at mobile community platform 1512, the member/user 1526 can interact with (e.g., view, purchase, utilize, evaluate, rate, etc.) a plurality of different third-party developer content 1508 that are registered to the mobile community 1512. For example, a new user may request access to a demo version of a third-party software application from the mobile community 1512; which results in the mobile community 1512 sending a webpage conferring access to the user. After interacting with the demo, the new user can choose whether to purchase (or subscribe) to a “full” version of the third-party software application. If the new user decides to purchase the full version of the third-party software application, the user may be required to first register with the mobile community 1512 (if he/she hasn't already done so). In another embodiment, when a new user arrives at the mobile community 1512, the user can be immediately directed to a registration screen that prompts the user to enter a variety of identifying information. For example, the registration process can result in the user providing an e-mail address and/or a mobile telephone number to the mobile community 1512.

As described above, the mobile community platform 1512 can store (using content database 1514) information related to the number of views and “click throughs” (i.e., search clicks) of web pages (i.e., content channels) and content 1508 (e.g., pod applications, multimedia files, podcasts, etc.) that are made available through the mobile platform 1512. Additionally, mobile platform 1512 can also have revenue information for such channels and content 1508, since platform 1512 generates the billing events and facilitates payment. Therefore, the content search engine 1512 can use this revenue, at least for the content channels and content 1508 provided through platform 1512, to prioritize the search results based on revenue and other measures, i.e., content metrics, of user interactions (e.g., views, “click throughs,” etc.).

For example, in one embodiment, the revenue information can be normalized for the number of “click throughs.” In other words, the search results can be prioritized based on how often a content channel or content 1508 file is able to monetize a “click through.” Thus, the search results can be prioritized by dividing the amount of revenue by the number of “click throughs.” In other embodiments, this information can be combined with the total number of “click throughs” and/or the total revenue generated by the mobile community platform 1512 to prioritize the results.

In still other embodiments, channels or content 1508 files that have no “click throughs” but are generating revenue can be prioritized based on the amount of revenue they generate over a certain set interval such a running number of searches that have been submitted to the search engine and/or time period (such as a previous number of day(s), week(s), year(s)). Similarly, content channels that have “click throughs” but no revenue can be prioritized based on the number of “click throughs” over a certain set interval such a running number of searches that have been submitted to the search engine and/or time period (such as a previous number of day(s), week(s), year(s)). Content channels that have no revenue and no “click throughs” can be prioritized based on the number of page views over a certain set interval such a running number of searches that have been submitted to the search engine and/or time period (such as a previous number of day(s), week(s), year(s)). In still another embodiment, some combination of the above prioritization methods can be used in order to sort all search results for presentation to the user. By prioritizing the search results based on revenue information and other measures, i.e., content metrics, of user interactions with the content channels and or content 1508, users can be provided with a more relevant search experience.

As discussed above, the content search engine 1512 can be utilized to search a plurality of content channels. A content channel can be created by, e.g., a user 1526 and/or a third-party content developer (e.g., 1502, 1503 or 1506). For example, platform 1512 can be configured to allow a user 1526 or third-party content developer to find and aggregate content 1508, e.g., from network enabled applications or other content sources or providers, into a channel. The aggregated content can then be organized and made available to other users 1526. In other words, the user 1526 or content provider can create their own programming channel, or content channel.

Each channel can be associated with a tag. The tags can be used to access the associated channel and for search purposes (as a descriptor of the content that is associated with the channel). For example, the channels can be accessed via tags listed across the bottom of the profile page. A visitor to the profile page can highlight a tag and activate a description window that includes a description of the content associated with the channel. The visitor can then add the channel to the visitor's profile page so that the visitor can then access the content 1508 associated with the channel.

There can be a charge associated with adding a channel to a user's 1526 profile page. For example, in certain embodiments a user 1526 can pay a fee each time they access the channel content. In other embodiments, the user 1526 can subscribe to a channel. The subscription can, e.g., cover a certain period of time, such as a month, a year, etc. In other embodiments, channel access can be free, and in still other embodiments, a combination of fees, subscription, and free access can be provided depending on the channel and the user's needs. When a user 1526 agrees to pay a subscription or fee, a billing event can be generated as described above.

Thus, not only can a user 1526 or third-party content developer aggregate content 1508 and create a channel(s), but users 1526 can then purchase access to a plurality of channels and make various content channels available for their own viewing through the users' 1526 profile pages. The content 1508 can then be accessed whenever and in whatever order a user 1526 desires, i.e., the user becomes the content programmer. In general, once a channel is purchased, e.g., either via a fee or a subscription, and added to a user's 1526 profile page, the channel can only be viewed by the owner of the profile page, i.e., in the private view.

The profile page can include a “Search Channels” option. Selecting this option can activate the content search engine 1524 which is configured to search through all channels available on platform 1512 and present a prioritized list of channels based on revenue information associated with the channels and/or other measurements of user 1526 interactions with the channel. The revenue information can be based on the subscriptions and fees paid when users 1526 add the various channels to their own profile pages.

In some embodiment, various content channel pages can be created and organized via tabs. For example, a “Racing” tab can include a plurality of channels related to cars and racing. Accordingly, a user 1526 or third-party content developer can create a plurality of content channel pages each including a plurality of content channels. Users 1526 can then pick and choose various channels from various pages of various profile pages. A user 1526 can select a channel by visiting various profile and content channel pages and selecting the channels that appeal to them, or by using the channel search feature. Moreover, a user 1526 can email a channel to a friend and/or rate the contents of the channel.

As discussed above, channels can be classified by the nature of the content, e.g., racing, cars, etc. Channels can also be classified based on the type of content that they contain, e.g., as music files, video files, application pods, podcasts, etc. Thus, the search results can be organized by channel content type.

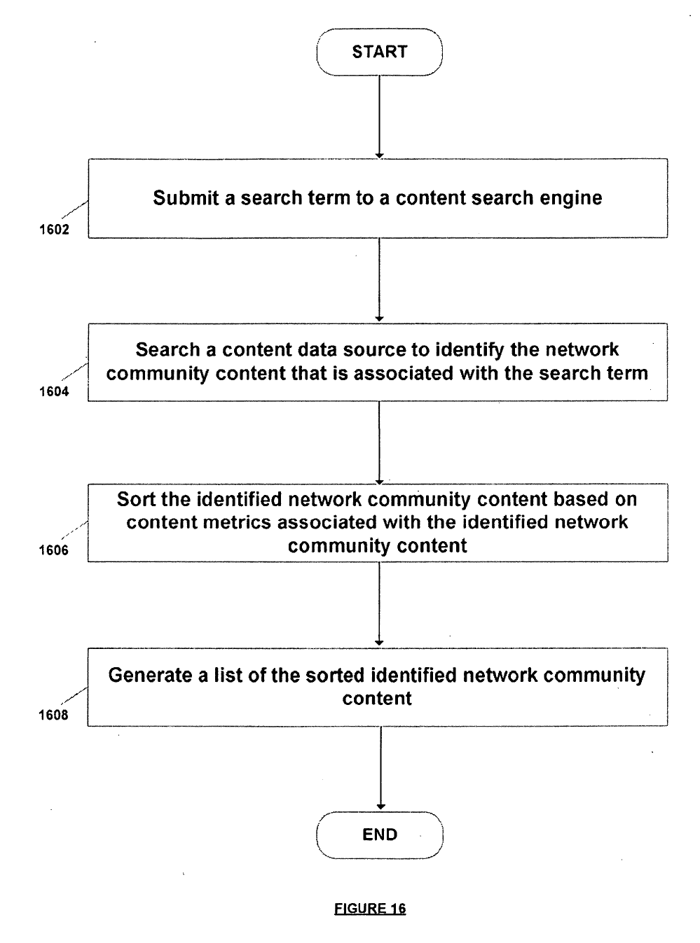

FIG. 16 is an example process for searching a mobile community platform for content and prioritizing the content search results based on one or more content metrics, in accordance with one embodiment. In step 1602, a mobile community platform user/member submits a search term to the content search engine. The search term can be submitted using a standalone search page or a search bar that is integrated into a web browser or other client-side interface utilized by the user/member to access the mobile community platform. In step 1604, the content data source (i.e., content database) is searched to identify content channels and/or content files (i.e., network community content) that are associated with the search term. In one embodiment, the identification of the network community content involves matching the search term with the titles of the network community content. In another embodiment, the identification of the network community content involves matching the search term with the tag assigned to the network community content.

In step 1606, the identified network community content are sorted based on content metrics associated with the network community content. That is, the content search engine can prioritize the identified network community content based on revenue and other measures, i.e., content metrics, of user interactions (e.g., views, “click throughs,” etc.).

For example, in one embodiment, the revenue information can be normalized for the number of “click throughs.” In other words, the search results can be prioritized based on how often the network community content is able to monetize a “click through.” Thus, the search results can be prioritized by dividing the amount of revenue by the number of “click throughs.” In other embodiments, this information can be combined with the total number of “click throughs” and/or the total revenue generated by the network community platform (i.e., mobile community platform) to prioritize the results.

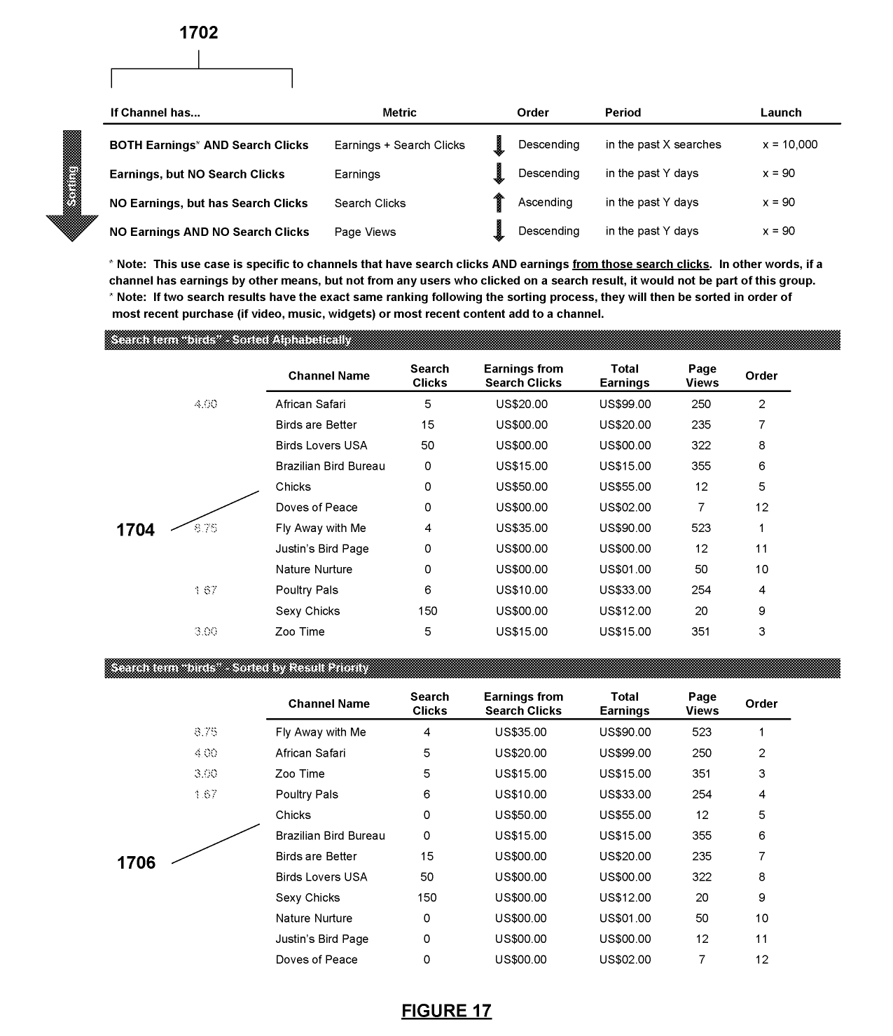

In still other embodiments, network community content that have no “click throughs” but are generating revenue can be prioritized based on the amount of revenue they generate over a certain set interval such a running number of searches that have been submitted to the search engine and/or time period (such as a previous number of day(s), week(s), year(s)). Similarly, network community content that have “click throughs” but no revenue can be prioritized based on the number of “click throughs” over a certain set interval such a running number of searches that have been submitted to the search engine and/or time period (such as a previous number of day(s), week(s), year(s)). Network community content that have no revenue and no “click throughs” can be prioritized based on the number of page views over a certain set interval such a running number of searches that have been submitted to the search engine and/or time period (such as a previous number of day(s), week(s), year(s)). In still another embodiment, some combination of the above prioritization methods can be used in order to sort all search results for presentation to the user. For example, as shown in FIG. 17, by prioritizing the search results based on revenue information and other measures, i.e., content metrics 1702, of user interactions with the network community content, users can be provided with a more relevant search experience.

In step 1608, a list of the sorted identified network content is generated and presented for viewing by the user. For example, FIG. 17 provides an example of a content search result list 1706 for the search term “birds” that has been sorted based on content metrics 1702 (e.g., earnings and search clicks information).

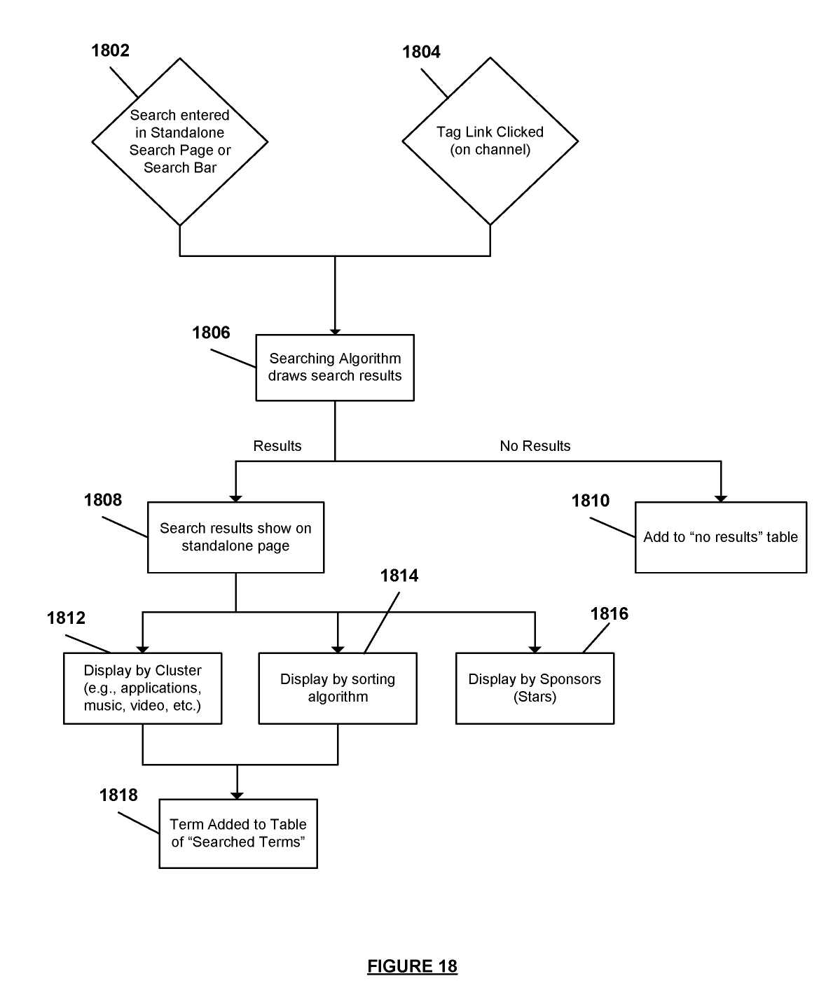

FIG. 18 is a logic flow diagram that illustrates the operation of the content search algorithm to enable a mobile community platform user to search the community platform for relevant content, in accordance with one embodiment. As depicted herein, the mobile community platform user can either submit a search term 1802 into a standalone search page or search bar that is integrated into the user's web browser or simply click on a tag link 1804 (that is embedded onto their personalized page or some other web page hosted by the mobile community platform). The submitted search term or tag link activates the content search engine 1806, which proceeds to execute one or more search algorithms to compile a list of search results. If the content search engine cannot find any community content that matches the search term or tag link, it will add the search term or tag link to a “no results” table 1810. If the content search engine matches the search term or tag link to one or more examples of mobile community content, it will compile and sort the matched mobile community content into a results list that is displayed on a standalone web page. Additionally, the searched term is also placed in a table 1818 of searched terms that have been matched with content on the mobile community platform.

As discussed previously, the content search results can be presented to the user in a number of different formats. In on embodiment 1812, the results can be displayed as clusters by content type (e.g., application pods, music files, video files, podcasts, etc.). In another embodiment 1814, the results can be displayed as a list that is sorted in accordance with a results sorting algorithm. For example, the search results can be prioritized based on revenue information and/or other measures, i.e., content metrics, of user interactions with the matched network community content. In still another embodiment 1816, the search results can be displayed by sponsors. That is, sponsored mobile community content can be given premium placement (i.e., positioned higher on the list than comparable non-sponsored mobile community content) on the final search results list.

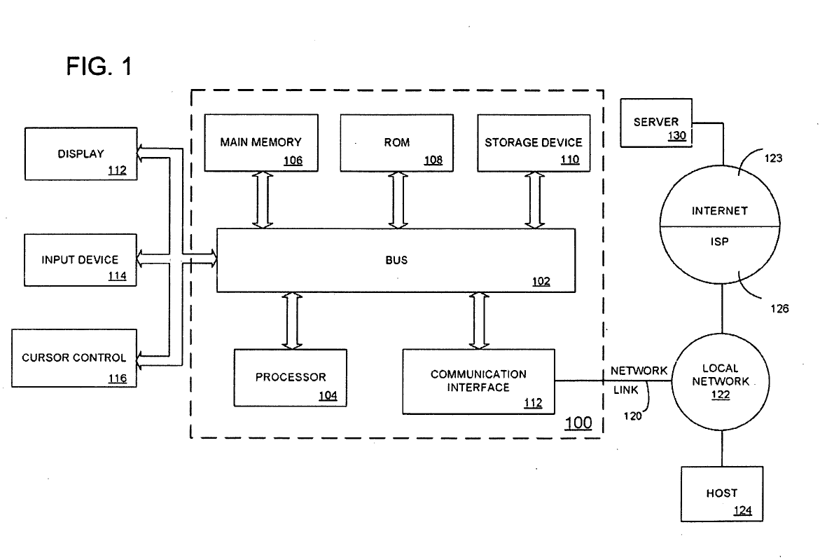

At least portions of the invention are intended to be implemented on or over a network such as the Internet. An example of such a network is described in FIG. 1. The description of the network and computer-based platforms that follows is exemplary. However, it should be clearly understood that the present invention may be practiced without the specific details described herein. Well known structures and devices are shown in block diagram form in order to avoid unnecessarily obscuring the present invention.

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hardwired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A system for searching a network community platform for network community content, comprising:
a content database communicatively connected to the network community platform, the content database configured to store the network community content and one or more content metrics associated with the network community content, wherein the one or more content metrics comprise a revenue metric based on revenue generated by the network community content; and
a content search engine communicatively connected to the network community platform and configured to
search the content database to identify network community content that is associated with a search term submitted by a network community platform user,
sort the identified network community content based on the one or more content metrics associated with the identified network community content, and
generate a list of the sorted identified network community content.

2. The system for searching a network community platform for network community content, as recited in claim 1, wherein the content database and the content search engine reside on the same computing device.

3. The system for searching a network community platform for network community content, as recited in claim 1, wherein the network community content is a content channel.

4. The system for searching a network community platform for network community content, as recited in claim 3, wherein the content channel is a web page that includes a particular content type.

5. The system for searching a network community platform for network community content, as recited in claim 4, wherein the content type is an application.

6. The system for searching a network community platform for network community content, as recited in claim 4, wherein the content type is a media file.

7. The system for searching a network community platform for network community content, as recited in claim 4, wherein the content type is a podcast.

8. The system for searching a network community platform for network community content, as recited in claim 1, wherein the network community content is a content file.

9. The system for searching a network community platform for network community content, as recited in claim 8, wherein the content file is one or more of a music file, a picture file, and a video file.

10. The system for searching a network community platform for network community content, as recited in claim 8, wherein the content file is a picture file.

11. The system for searching a network community platform for network community content, as recited in claim 8, wherein the content file is a video file.

12. The system for searching a network community platform for network community content, as recited in claim 1, wherein the revenue metric is a ratio of total earnings generated by the network community content and search clicks associated with the network community content over a set interval.

13. The system for searching a network community platform for network community content, as recited in claim 1, wherein the revenue metric comprises a total earnings generated by the network community content over a set interval.

14. The system for searching a network community platform for network community content, as recited in claim 1, wherein the one or more content metrics further comprise a number of search clicks associated with the network community content over a set interval.

15. The system for searching a network community platform for network community content, as recited in claim 1, wherein the one or more content metrics further comprise a number of user views of the network community content over a set interval.

16. The system for searching a network community platform for network community content, as recited in claim 12, wherein the set interval is a time period.

17. The system for searching a network community platform for network community content, as recited in claim 12, wherein the set interval is a number of searches submitted.

18. The system for searching a network community platform for network community content, as recited in claim 1, wherein the association of the search term with the network community content is made by matching the search term with titles of the network community content.

19. The system for searching a network community platform for network community content, as recited in claim 1, wherein the association of the search term with the network community content is made by matching the search term with tags assigned to the network community content.

20. A method for searching a network community platform for network community content, comprising:
submitting a search term to a content search engine;
searching a content database to identify the network community content that is associated with the search term;
sorting the identified network community content based on one or more content metrics associated with the identified network community content, wherein the one or more content metrics comprise a revenue metric based on revenue generated by the network community content; and
generating a list of the sorted identified network community content.
